(19) United States
(12) Patent Application Publication
(10) Pub. No.: US 2006/0201959 A1
(43) Pub. Date: Sep. 14, 2006

(54) Lid/cover and hinge apparatus

(75) Inventor: Douglas Lee Hornbeck, Cheyenne, WY (US)

Correspondence Address: RUBEN C. DELEON;WINSTEAD SECHROST & MINICK P.C., P.O. BOX 50784, DALLAS, TX, 75201, US

(73) Assignee: American Permanent Ware Corporation, Dallas, TX (US)

(21) Appl. No.: 11/078,740

(22) Filed: Mar. 11, 2005

(51) Int. Cl. B65D 43/14; A47J 37/01

(52) U.S. Cl. 220/841; 220/573.1; 220/912

(57) ABSTRACT

A lid and hinge apparatus for food serving pans is provided comprising a lid having a first lid member and second lid member each having a top and bottom surface, wherein the first lid member further includes a utensil aperture, a plurality of perimeter flanges, and wherein one perimeter flange includes a first generally vertically extending hinge flange portion having a slotted receiving cavity, wherein the cavity is disposed generally horizontal and parallel to the top surface of the first member. The lid further comprises an integrally formed major and a minor flange, wherein the major and minor flanges include a plurality of arcuate folds thereon, wherein the major and minor flanges function to provide a removable and hingeable cooperation of the lid/cover first and second members.

### FIELD OF INVENTION

This invention is generally directed to a closure for a food container. Particularly, it relates to a removable lid for a pan. More particularly, the invention is directed to a removable lid and hinge cover apparatus for covering and maintaining food in a safe, fresh, and clean environment in a food pan, wherein the lid may be hinged open for food service or removed in whole or in part for exposing the interior of the pan for food service and/or cleaning.

### BACKGROUND OF INVENTION

Food serving pans used in food servers such as steam tables, chill tables, salad bars or the like for containing various food items in a cold or hot state and allowing the food to be served in portions have been used for many years in commercial and non-commercial food service establishments. Many pans are typically rectangular or square topped stainless steel pans with an open top and having the capability to store various capacities of food. A flange usually extends around the circumference of the pan to provide a steam seal around a steam table or to aid in removal of the pan from its resting location in the table.

Lids or covers are typically provided for such pans to keep the food hot or cold, to prevent food drying, as well as to reduce contamination by servers, insects, or other sources. The most common lids/covers are substantially flat metal sheets with a handle disposed on top to allow for removal of the lid/cover when serving food or for cleaning. This presents problems to the server. One problem is that the lid must be completely lifted and removed by one hand to serve the food, thereby allowing only one hand to serve the food.

Another problem is that sometimes it is desirable to leave a serving utensil in the pan while keeping the lid closed to keep the food warm and/or to prevent contamination from outside sources. In such situations, if the utensil is left in the pan with the lid in place, a majority of the lid is caused to be partially propped open by the remaining utensil. Complicating the problem is the risk of contamination if the covers are left with the serving utensil still in the pan. In addition, if the utensil is completely removed to allow for full closure of the lid and then placed on an unclean surface and then replaced into the food serving pans, the utensil may contaminate the remaining food within the pan upon reinsertion.

One solution has been to provide pans with a two-piece lid or cover. One problem with this design is that generally most two-piece lids are typically joined together by a piano style hinge or similar pin. This type of hinge allows for a first part of the lid to hinge or rotate about a pin within the piano style hinge which serves to connect a generally stationary second part of the hinge to the first part. This hinge design disadvantageously allows food product and other contaminates to accumulate on and in the hinge and occasionally allows the contaminates to simply pass through the hinge and into the pan containing the food. Moreover, because this type of hinge tends to permanently attach the first and second part of the lid or cover together, it does not permit easy disassembling for cleaning purposes. Therefore, this design does not meet current UL sanitation or NSF/ANSI standards.

Yet another problem exists in current lid and cover designs. Specifically, ledges and slots are formed on and in many hinge designs that allow contaminates to accumulate on the ledge or slot when the lid or cover is in the open and/or closed position. When the contaminate (e.g., food product) dries out or cools down below acceptable limit standards and the lid is then closed, the contaminate is essentially “pushed” back down and into the pan with the usable product.

There is a need, therefore, for an improved means for covering a food serving pan or the like. In particular, there is a need for a lid and/or cover and hinge apparatus that permits a utensil to remain in the pan while the lid is closed. In addition, there is a need for an improved lid/cover and hinge apparatus that is easy to disassemble, clean and sanitize. Furthermore, there is a need for an improved lid and/or cover and hinge apparatus that eliminates the common ledges or grooves found in current lids and provides for an improved hinge that when hinged open will direct contaminates down the hinge and over the sides of the pan instead of into the pan containing a useable food product.

### SUMMARY OF INVENTION

To the accomplishment of the foregoing and related ends, the invention comprises the features hereinafter fully described and particularly pointed out in the claims. The following description and the annexed drawings set forth in detail certain illustrative embodiments of the invention. These embodiments are indicative of but a few of the various ways in which the principles of the invention may be employed. Other objects, advantages and novel features of the invention will become apparent from the following detailed description of the invention when considered in conjunction with the drawings.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The present invention discloses a lid/cover and hinge apparatus for food serving pans that is intended to address to the needs and problems discussed above.

In summation, the present invention comprises a lid/cover and hinge apparatus having a first lid member and second lid member each having a top and bottom surface, wherein the first lid member further includes a geometric serving utensil aperture, a plurality of perimeter flanges, wherein one portion of a perimeter flange is formed to function as a handle, and wherein one perimeter flange includes a first generally vertically extending hinge flange portion having a slotted receiving cavity, wherein the cavity is generally horizontal and parallel to the top surface of the first member, wherein the generally vertical hinge flange further comprises an upper portion arcuate fold configured thereon.

The lid/cover second lid member comprises a major and a minor flange integrally formed thereon in a cooperative arrangement, wherein the major and minor flanges include a plurality of arcuate folds thereon, wherein the major and minor flanges function to provide an second generally vertically extending hinge portion for permitting a removable and hingeable cooperation of the lid/cover first and second lid members. The second lid member further comprises a plurality of perimeter flanges disposed in a downward arcuate bending fashion.

A method for hingeably joining the lid/cover and hinge apparatus of the present invention is provided comprising the steps of insertably engaging a minor flange of the lid/cover and hinge apparatus second lid member into a generally horizontal and parallel cavity formed in the first generally vertically extending hinge flange portion of the first lid member, wherein when the first and second members are engaged permits a user to open and close the first lid member, when the lid/cover and hinge apparatus is mounted on a pan, without permitting contaminates that have fallen onto the top surfaces of the lid/cover and hinge apparatus to enter the pan and contaminating the entire pan contents. The method further comprises the steps of opening or lifting the first lid member and slidably disengaging the first generally vertically extending hinge flange portion having a cavity from the vertically extending insertable hinge portion having edgeline of the second lid member to disengage the first and second members therefrom each other and slidably disengaging the second lid member from the pan, thereby permitting cleaning and sanitizing of the first and second lid members.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

These and other objects, features and advantages of the present invention will be more readily apparent when considered in connection with the following, detailed description of preferred embodiments of the invention, which description is presented in conjunction with annexed drawings below.

### BRIEF DESCRIPTION OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1A is a perspective view of the lid/cover and hinge apparatus for a food pan or the like shown with the first and second lid members disengaged according to the present invention;

FIG. 1B is a perspective view of the lid/cover and hinge apparatus shown with the first and second lid member hingeably engaged in a closed position according to the present invention;

FIG. 2 is a perspective view of the lid/cover and hinge apparatus shown with the first and second lid members hingeably engaged with the first lid member resting in an open position according to the present invention;

FIG. 3A is a view of the top of the first lid member according to the present invention;

FIG. 3B is a view of the bottom of the first lid member according to the present invention;

FIG. 4A is a plan view of the handle end of the first lid member according to the present invention;

FIG. 4B is a plan view of the hinge end of the first lid member according to the present invention;

FIG. 5A is a plan view of the non-hinging end of the second lid member according to the present invention;

FIG. 5B is a left side view of the second lid member according to the present invention;

FIG. 5C is a right side view of the second lid member according to the present invention;

FIG. 5D is a view of the top surface of the second lid member according to the present invention; and

FIG. 5E is a view of the bottom surface of the second lid member according to the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

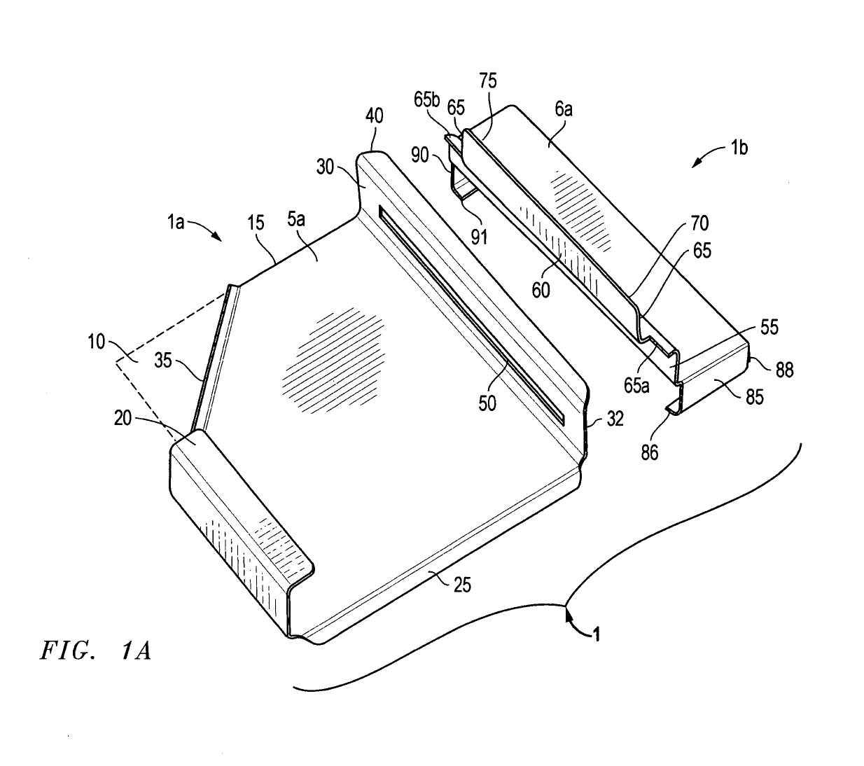

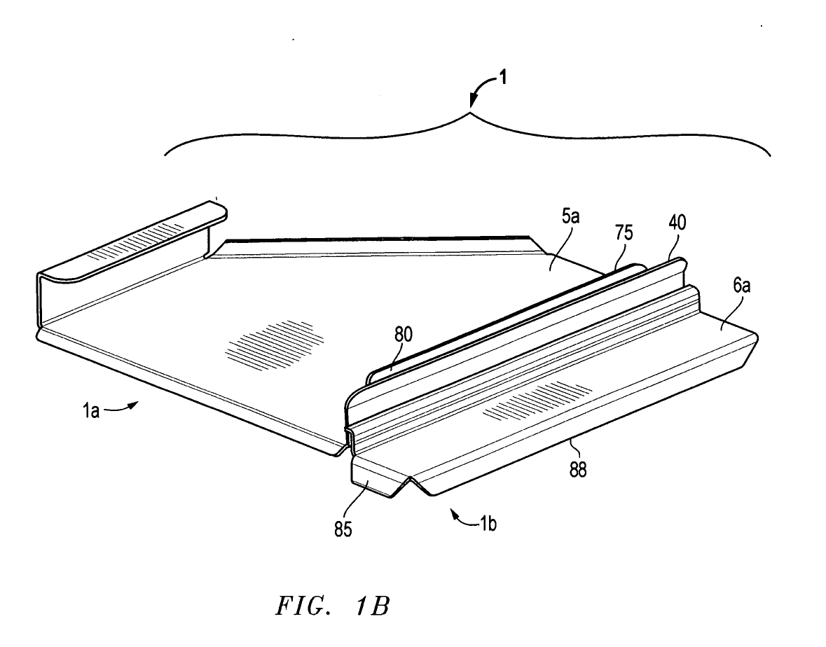

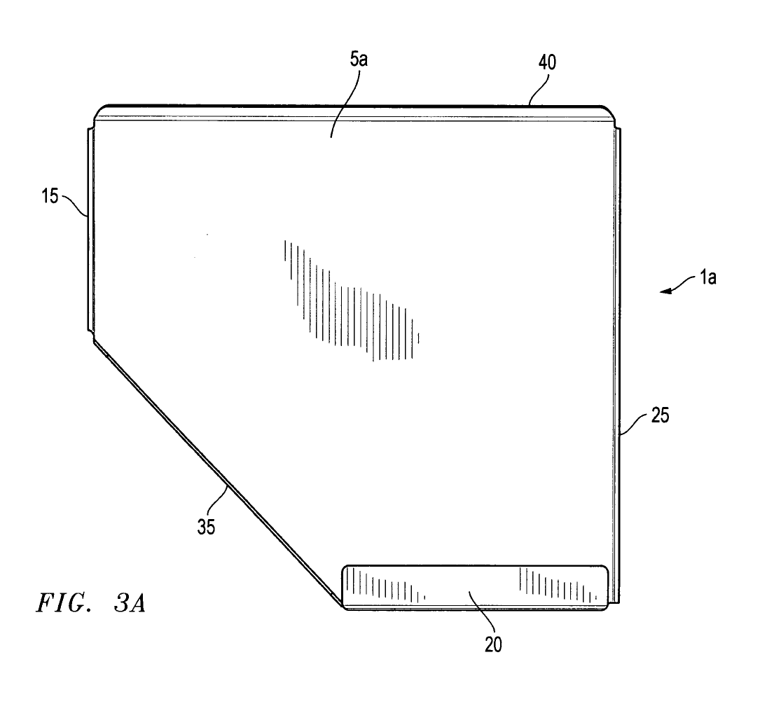

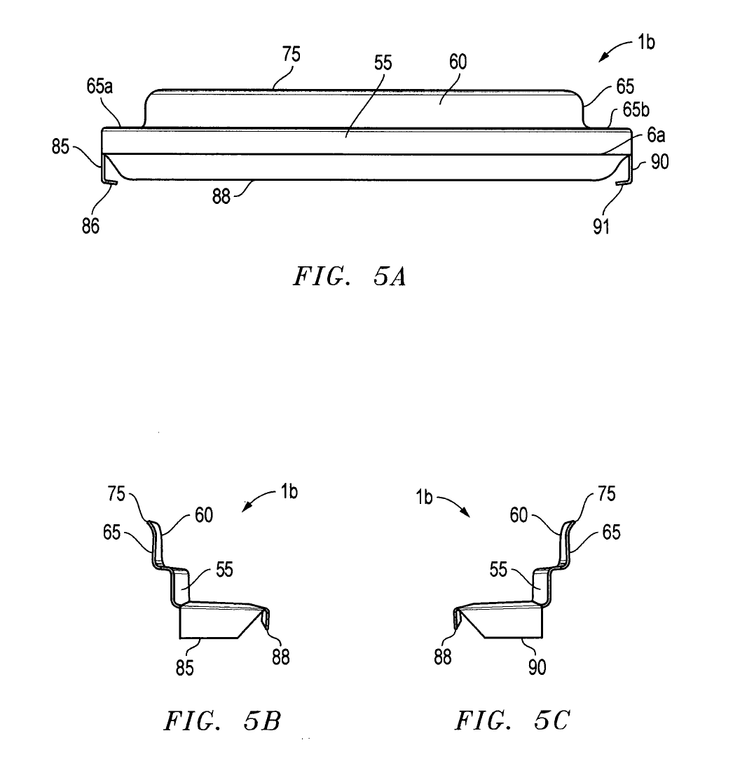

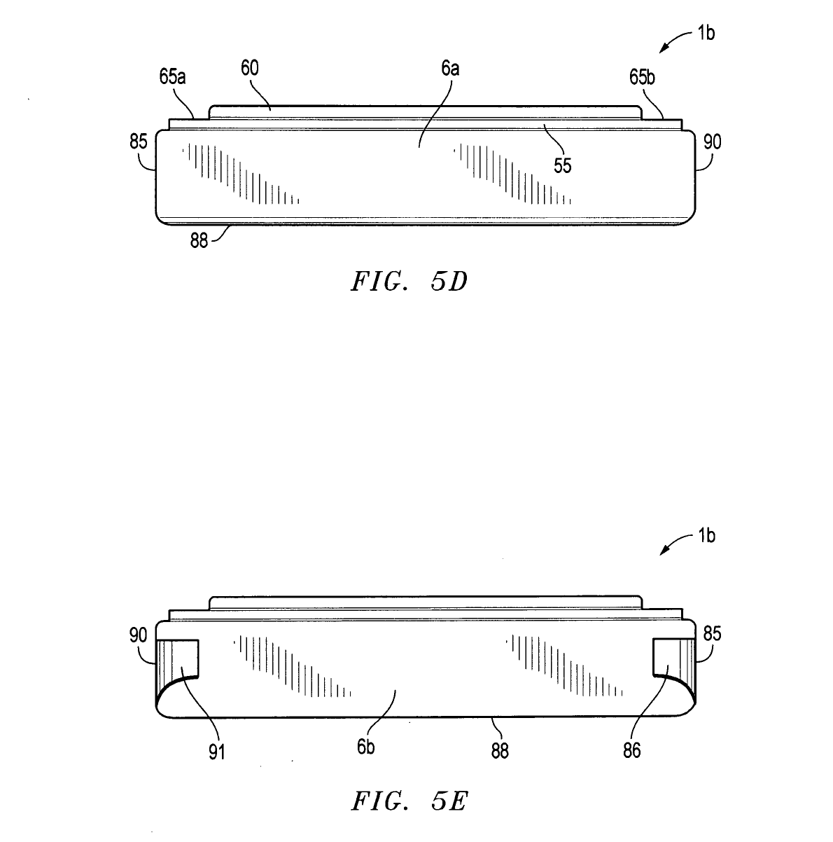

With reference now to FIGS. 1A-5E, specifically FIG. 1A, the present invention comprises a lid/cover 1 preferably made of metal, most preferably stainless steel or other similarly rigid material, but is not limited thereto. The lid 1 comprises a first lid member 1a and second lid member 1b each having a top surface 5a, 6a (respectively) and a bottom 5b, 6b surface (respectively) (shown in FIGS. 3B and 5E, respectively), wherein the first lid member 1a further includes a geometric serving utensil aperture 10 formed thereon a portion of the first lid member 1a. The aperture 10 is made by removing a geometric triangular corner portion of the first member 1a. It will be understood by one skilled in the art that the size, shape, and positioning of the aperture 10 created may vary according to desired design specifications and pan (not shown) arrangements. An upwardly extending flange 35 is then formed along the triangular corner portion of first lid member 1a by slightly bending the material up about ¼ inch to prohibit contaminates from entering into the pan via the aperture 10.

One embodiment of the first lid member 1a has a generally rectangular dimension of about 5 ½ inches by 6 inches and having a material thickness of about 1/16 of an inch. However, the thickness may be varied without detracting from the scope and spirit of the present invention. The present invention discloses a lid as described herein as being designed for a plurality of pan sizes including, but not limited to a ⅙ size pan lid and ⅓ size pan lid. It will be understood by one skilled in the art that the size, shape, and thickness of the first lid member 1a may be adjusted accordingly based upon pan specifications.

The first lid member 1a further comprises a plurality of perimeter flanges 15, 20, 25, 30, 35. Specifically, perimeter flange 20 is formed having a vertical and horizontal portion which together function as a handle for raising and lowering the lid's 1 first lid member 1a while positionally seated on a pan (not shown). Also, flange 20 also serves as a deflecting member to assist in preventing contaminates from entering the pan in this area of the first lid member 1a. Perimeter flange 20 extends upward from the top 5a of the first lid member 1a about ¾ of an inch.

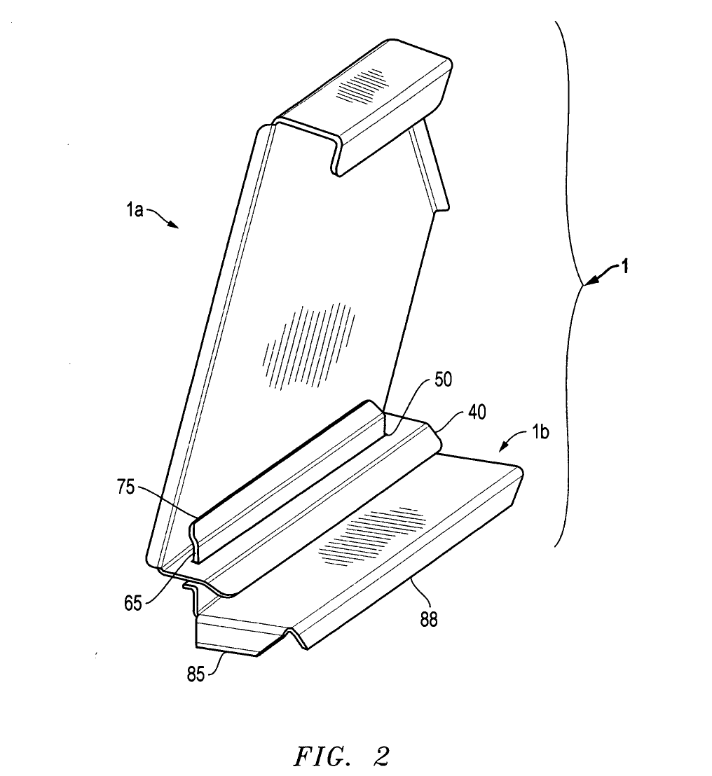

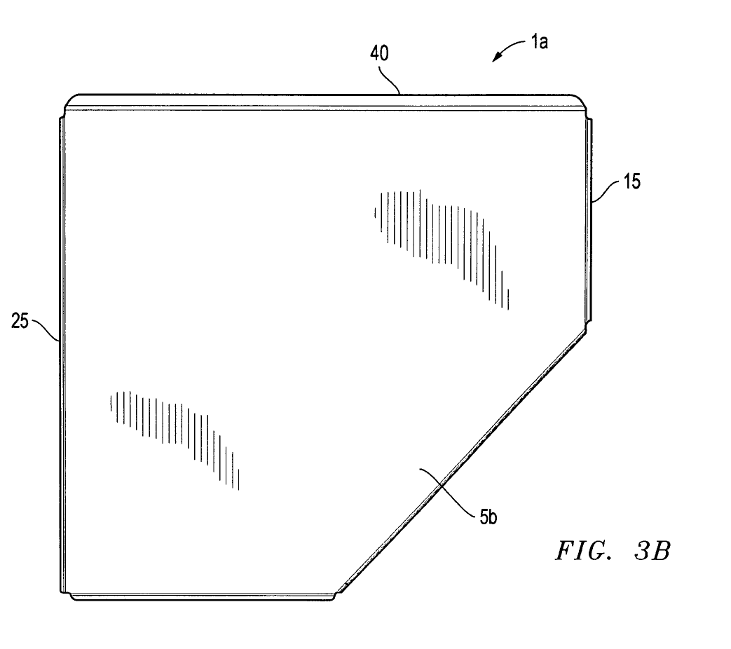

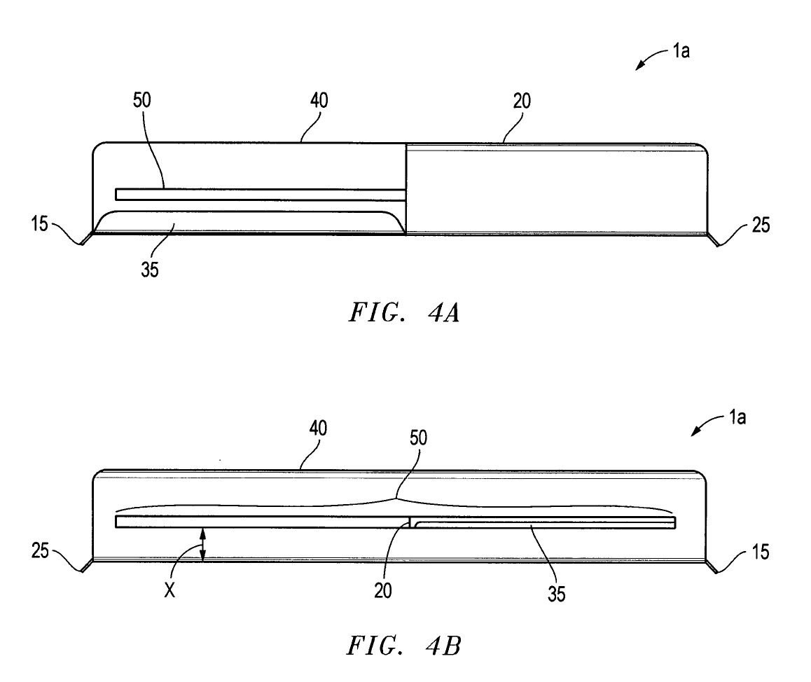

According to the present invention, perimeter flange 30 comprises a generally vertically extending hinge flange portion 32 having a longitudinally disposed slotted receiving pivot cavity 50, having an internal cavity longitudinal length dimension of about 5 ⅛ inches and internal cavity height of about ⅛ inch, wherein the pivot cavity 50 is formed generally parallel to the top surface 5a of the first lid member 1a and having a displacement, indicated by “X” (clearly shown in FIG. 4B), of at least 3/16 of an inch above the top surface 5a, which meets NSF/ANSI standards. The first generally vertical hinge flange 32 further comprises an upper portion arcuate fold 40 configured thereon which serves to retard the motion of the lid/cover 1 first lid member 1a when resting in a fully open position (as shown in FIG. 2).

The lid/cover 1 second lid member 1b comprises a major flange 55 and a minor flange 60 that are integrally formed thereon a portion of the second lid member's 1b top surface 5b. The major flange 55 is formed thereon the second lid member 1b in such a fashion as to expand the width of the second lid member 1b. A plurality of seating notches 65a, 65b are formed on each distal end of the major flange 55. These seating notches 65a, 65b permit the first generally vertical hinge flange 32 of the first lid member 1a to be seated and rest against each notch 65a, 65b in a cooperative arrangement when the first lid member 1a and second lid member 1b are pivotally engaged for opening and closing the first member 1a as will be explained below. One embodiment of the second lid member 1b has a generally rectangular dimension of about 6 ¼ inches by 1 ¼ inches and having a material thickness of about 1/16 of an inch. However, the thickness may be varied without detracting from the scope and spirit of the present invention. Similar to the first lid member 1a, it will be understood by one skilled in the art that the size, shape, and thickness of the second lid member 1b may be adjusted as desired based upon pan specifications.

Furthermore, the major 55 and minor 60 flanges comprise a plurality of arcuate folds thereon. More specifically, the minor flange 60 functions to provide a generally vertically extending insertable hinge portion 65, wherein the vertically extending insertable hinge portion 65 has an upper portion arcuate fold 70 configured thereon for permitting a removable and hingeable cooperation of the lid/cover 1 first lid member 1a and second lid member 1b. Similar to upper portion arcuate fold 40 of first lid member 1a described above, edgeline 75 of minor flange 60 also functions to retard the motion of the first lid member 1a when pivotally resting in longitudinally disposed slotted receiving pivot cavity 50 in a fully open position as shown in FIG. 2.

Also, as depicted in FIG. 1B, when the first lid member 1a and second lid member 1b are pivotally engaged and are cooperatively confronting each other in a closed resting position as shown, a generally v-shaped trough 80 is formed that allows contaminates (liquid and/or solid) that are dropped into this trough 80 portion of the engaged lid members, 1a and 1b, to be forced to exit along the trough 80 and flow down onto the top 5a of the first lid member 1a and over-the-edge of the downward arcuate bends in perimeter flanges 15 and 25 as shown in FIG. 1. Such arcuate bends in perimeter flanges 15 and 20 function also to provide an overlapping feature with a mated pan, which also prevent contaminates from entering the pan. These detailed features allow the overall lid 1 design of the present invention to meet and/or exceed current UL sanitation or NSF/ANSI standards.

As shown in FIGS. 1A, 1B, 2, and 5A-5E, the second lid member 1b also comprises a plurality of downward arcuate bends in perimeter flanges 85, 90. Perimeter flanges 85, 88, 90 function to promote an over-the-edge downward flow of contaminates that may be spilled onto the surface of the top 5b of the second lid member 1b. Perimeter flanges 85, 88, 90 further comprise lid to pan attachment lips 86 and 91, respectively, which enable the second lid member 1b to be slidably and removably engaged with a pan (not shown) and permit the attached lid/cover and hinge apparatus 1 and pan combination to rest in a food steam table (not shown) or the like. It should be understood that the lid/cover and hinge apparatus 1 of the present invention may be dimensionally configured to adapt to an unlimited number of size pans that are commonly found and used in the food service industry or other industries utilizing such lids.

FIG. 2 depicts the lid/cover and hinge apparatus 1 with the first lid member 1a in a fully open position having arcuate fold 40, described above, and edgeline 75 of the minor flange 60 of the second lid member 1b functioning to retard further opening of the first lid member 1a.

FIG. 3A depicts the top 5a of the first lid member 1a of the present invention showing key elements 15, 20, 25, 35 and 40 as described above.

FIG. 3B depicts the bottom 5b of the first lid member 1a of the present invention showing 15, 25, and 40 as described above.

FIG. 4A depicts an end view, shown from the handle end, of the first lid member 1a. Shown are the primary elements of first lid member 1a such as, but not limited to, downward arcuate bending perimeter flanges 15 and 25, perimeter flange 20 (which functions as a handle as described), upwardly extending flange 35, upper portion arcuate fold 40, and longitudinally disposed slotted receiving pivot cavity 50.

FIG. 4B depicts a hinge end view of the first lid member 1a. Shown are the same elements as described above in relation to FIG. 4A.

FIG. 5A depicts a non-hinge end view of the second lid member 1b. Specifically shown for clarity of configuration is the second lid member's 1b top surface 6a, major flange 55 as described above, minor flange 60, wherein minor flange 60 comprises generally vertically extending insertable hinge portion 65 having edgeline 75. Further depicted are the plurality of seating notches 65a, 65b formed on each distal end of the major flange 55 as described above. Also shown are the plurality of perimeter flanges 85, 90 having downward arcuate bends formed therein, which create pan attachment lips 86 and 91 for enabling the second lid member 1b to be slidably and removably engaged with a pan (not shown) and permit the attached lid 1 and pan combination to rest in a food steam table (not shown) or the like. Also shown is end perimeter flange 88 which acts as a stop for second lid member 1b when being slidably engaged and positioned on the pan.

FIGS. 5B and 5C depict a left side view (FIG. 5B) and a right side view (FIG. 5C) of the second lid member 1b, wherein perimeter flanges 85, 90, end perimeter flange 88, and vertically extending insertable hinge portion 65 of minor flange 60, which includes edgeline 75, are shown for visual clarity of configuration.

FIG. 5D depicts a view from the top of the top surface 6a of second lid member 1b. Further shown for visual clarity of configuration in FIG. 5D are perimeter flanges 85, 90, end perimeter flange 88, seating notches 65a, 65b, minor flange 60, and major flange 55.

FIG. 5E depicts a view from the bottom of the bottom surface 6b of the second lid member 1b. Specifically shown for understanding are perimeter flanges 85 and 90 which are bent arcuately downward to form thereon pan attachment lips 86 and 91 as described hereinabove.

It will be understood by one skilled in the art that the lid/cover and hinge apparatus 1 of the present invention is not limited to the dimensions specified above. Specifically, it should be understood that the dimensions of the first lid member 1a and second lid member 1b and associated element configurations may be altered to allow adaptation with a plurality of pan sizes.

A method for hingeably and pivotally joining the lid/cover and hinge apparatus 1 of the present invention is provided comprising the steps of insertably engaging a minor flange 60 of the lid/cover and hinge apparatus 1 second lid member 1b into a generally horizontal and parallel cavity 50 formed in the first generally vertically extending hinge flange portion 32 of the first lid member 1a, wherein when the first 1a and second 1b members are engaged permits a user to open and close the first lid member 1a, when the lid/cover and hinge apparatus 1 is mounted on a pan, without permitting contaminates that have fallen onto the top surfaces 5a, 6a of the lid/cover and hinge apparatus 1 to enter the pan and contaminating the entire pan contents. The method further comprises the steps of opening or lifting the first lid member 1a and slidably disengaging the first generally vertically extending hinge flange portion 32 having cavity 50 from the vertically extending insertable hinge portion 65 having edgeline 75 of the second lid member 1b to disengage the first 1a and second 1b members therefrom each other and slidably disengaging the second lid member 1b from the pan, thereby permitting cleaning and sanitizing of the first 1a and second 1b lid members.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired.

It is therefore, contemplated that the claims will cover any such modifications or embodiments that fall within the true scope of the invention.

What is claimed is:

1. A lid for a pan, the lid comprising:
a first lid member, the first lid member having a plurality of peripheral flanges, wherein at least one flange comprises a generally horizontal and longitudinally disposed hinge pivot cavity;
a second lid member, the second lid member having a plurality of flanges, wherein the plurality of flanges comprise a major and minor flange, the major and minor flange being adapted for removable engagement with the first lid member's longitudinally disposed hinge pivot cavity.

2. The lid of claim 1 wherein the first lid member comprises a serving utensil cavity formed therein a portion of the first lid member.

3. The lid of claim 2 wherein a portion of the first lid member is comprised of a generally vertically extending hinge flange portion.

4. The lid of claim 3 wherein the generally vertically extending hinge flange portion comprises an upper portion arcuate fold portion formed thereon the generally vertically extended hinge flange portion.

5. The lid of claim 2 wherein the serving utensil cavity is formed by removing a corner section of the first lid member, wherein an arcuate upward bend flange is then formed on the corner section.

6. The lid of claim 4 wherein the arcuate upward bend flange is formed by bending the first lid member up by about ¼ of an inch, thereby preventing a surface contaminate located on the lid from entering the pan along the utensil cavity.

7. The lid of claim 1 wherein at least one of the peripheral flanges on the first lid member is formed as a handle, the handle extending upward about ¾ of an inch from the top surface of the first lid member, wherein the handle comprises at least one vertical and horizontal portion.

8. The lid of claim 1 wherein the first and second lid members are made of metal.

9. The lid of claim 7 wherein the metal is preferably stainless steel or other similarly rigid materials.

10. The lid of claim 9 wherein the lid is a ⅙ size pan lid.

11. The lid of claim 9 wherein the lid is a ⅓ size pan lid.

12. The lid of claim 1 wherein the first lid member has a general dimension of about 5 ½ inches by 6 inches, the first lid member having a material thickness of about 1/16 of an inch.

13. The lid of claim 1 wherein the hinging pivot cavity has an internal cavity length of about 5 ⅛ inches and an internal cavity height of about ⅛ inch.

14. The lid of claim 12 wherein the hinging pivot cavity is disposed at least 3/16 of an inch above the top surface of the first lid member.

15. The lid of claim 1 wherein the second lid member major flange portion further comprises a plurality of seating notches formed distally thereon the major flange, thereby permitting seated cooperative hinging engagement with the first lid member when pivotally engaged therewith.

16. The lid of claim 1 wherein the second lid member has a general dimension of about 6 ¼ inches by 1 ¼ inches and having a material thickness of about 1/16 of an inch.

17. The lid of claim 1 wherein the second lid portion minor flange comprises an edgeline formed by an upper portion arcuate fold thereon, wherein the seated pivotal confronting engagement of the first and second lid members form a generally v-shaped trough adjacent to the edgeline for effecting contaminate displacement down onto the lid top surfaces, thereby permitting the contaminants to exit down and over-the-edge of the lid surfaces.

18. The lid of claim 17 wherein the contaminants exit down and over-the-edge of the lid surfaces by way of a plurality of downward arcuate perimeter flange bends disposed thereon the first and second lid member, wherein the bends further function to create pan overlap.

19. The lid of claim 1 wherein the plurality of flanges of which comprise at least two lid-to-pan attachment lips, thereby enabling at least the second lid member to be slidably and removably engaged with a pan, thereby further permitting the lid and pan engaged combination to rest in a table: dimensioned to accomodate such lid and pan combinations.

20. A method for pivotally connecting a lid and hinge apparatus, the method comprising the steps of:
providing a first lid member, the first lid member comprising a first generally vertically extending hinge flange portion, having a pivotally hinging cavity formed therein the first lid member's first generally vertically extending hinge flange portion;
providing a second lid member having a plurality of flanges, wherein the plurality of flanges comprise a major and minor flange, the minor flange being dimensionally adapted for insertable removable pivotal connection with the first lid member; and
inserting the minor flange into the pivot hinge cavity and engagably seating the first and second lid member, wherein when engaged form a hingeable lid unit having at least one contaminant deflecting means and further having a plurality over-the-edge perimeter arcuate bends for preventing contaminants from entering a pan.

21. The method of claim 20 wherein the method further comprises steps for disengaging the pivotally connected lid members, the steps comprising:
lifting the first lid member; and
slidably disengaging the first generally vertically extending hinge flange portion of the first lid member from the minor flange of the second lid member, thereby permitting cleaning and sanitation of the first and second lid members.
